(19) United States
(12) Patent Application Publication
(10) Pub. No.: US 2014/0195568 A1
(43) Pub. Date: Jul. 10, 2014

(54) OBJECT DATABASE AND OBJECT DATABASE IMPROVING METHOD

(71) Applicants: Philip Mathuis, Brussels (BE); Serge Jooris, Brussels (BE); Olivier Magniette, Deurle (BE)

(72) Inventors: Philip Mathuis, Brussels (BE); Serge Jooris, Brussels (BE); Olivier Magniette, Deurle (BE)

(73) Assignee: OVIZIO IMAGING SYSTEMS NV/SA, Brussels (BE)

(21) Appl. No.: 14/233,689

(22) PCT Filed: Jul. 19, 2012
(86) PCT No.: PCT/EP2012/064228

§ 371 Date: Jan. 17, 2014

(30) Foreign Application Priority Data
Jul. 19, 2011 (EP) 11174583.2
Nov. 21, 2011 (EP) PCTEP/2011/070581
Jul. 16, 2012 (EP) EP2012/063937

(51) Int. Cl. G06F 19/00; G06F 17/30

(52) U.S. Cl. CPC G06F 19/32; G06F 17/30365; G06F 17/30607
USPC 707/812

(57) ABSTRACT

The current invention concerns an object database comprising a set of object entries, which comprise object properties, whereby said object properties comprise obtained object properties, which comprise DHM-obtained object properties and preferably object identification properties, characterized in that said DHM-obtained object properties comprise properties about a sample comprising said objects, said information derived from information acquired by a digital holographic microscope (DHM) and whereby preferably said object identification properties comprise information about the objects which allow identification of the object between the object database and an database. The invention furthermore discloses an object database updating method and a computing system comprising an object database and object database updating method as disclosed in the current invention.

### TECHNICAL FIELD

The invention pertains to the technical field of collecting and deriving properties from objects through digital holographic microscopy, whereby these properties are stored in an object database which can be updated, based on the feedback of users.

### BACKGROUND

Optical information systems have proven to be very useful in the design of two-dimensional (2D) pattern recognition systems. Recently, interest in three-dimensional (3D) optical information systems has increased because of its vast potential in applications such as object recognition, object identification, image encryption as well as 3D display. Digital holography is attractive for visualization and acquisition of 3D information for these various applications. In digital holography, 3D complex (magnitude and phase) information can be reconstructed at arbitrary depths and perspectives. The 3D complex information might provide more discriminant features for the recognition and specification of objects, or components and features within an object. The nature of the objects analyzed by Digital Holographic Microscopy (DHM) can be diverse and situated in multiple fields, such as for instance cytology, bacteriology, the study of micro-organisms, in diagnostic fields, for crime investigations, etc. Furthermore, the object may take various configurations, as it may be in liquid or solid form or opaque, translucent or transparent.

As DHM provides for a technique which is able to generate a vast amount of data related to a studied object, it is desirable to provide tools which can analyze the collected data in a straightforward manner, as well as providing a database comprising both the gathered information by DHM and the analysis tools.

U.S. Pat. No. 7,616,320 describes a method for identifying micro-organisms present in a sample comprising micro-organisms by digital holographic microscopy. Identification occurs by obtaining 3D information through DHM whereby the obtained images are compared to and correlated with a database of images of known micro-organisms.

Several challenges accompany the comparison of images obtained by DHM. Not all objects, analyzable by DHM, are suitable to be subjected to image-comparing algorithms as envisioned by U.S. Pat. No. 7,616,320. Furthermore, as the size of the obtained images from an object by DHM is rather large, sending them to an external database for image analysis and comparison will be rather cumbersome, and may take up an enormous amount of bandwidth and time. Furthermore, the comparison algorithms of the prior art are to be seen as static, and do not evolve in time, nor do they take new findings or improvements into account.

Accordingly, there is a need to overcome the aforementioned problems of existing techniques for analyzing holographic information obtained from an object by DHM. It is the object of current invention to solve at least one of the aforementioned problems.

### SUMMARY OF THE INVENTION

The current invention aims to provide a dynamic tool for the analysis of holographic information obtained from an object. Techniques currently exist for obtaining a vast range of properties linked to objects by use of Digital Holographic Microscopy (DHM), but there is a need for improved techniques for the analysis and interpretation of such obtained data. Therefore, the present invention provides for an object database according to claim 1.

In a related aspect, the current invention discloses a system of a database according to claim 1 and at least one DHM linked to said database as described in claim 16.

In a further aspect, the invention discloses a database updating method according to claim 11. The method allows for the establishment and maintenance of a dynamic database, which ensures accuracy and reliability of the derived object information.

In a final aspect, the invention provides for a computing system according to claim 17.

### DETAILED DESCRIPTION OF THE INVENTION

The present invention concerns an object database and an object database updating method, whereby holographic information is obtained from an object by means of digital holographic microscopy (DHM).

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of ±20% or less, preferably ±10% or less, more preferably ±5% or less, even more preferably ±1% or less, and still more preferably ±0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight” (weight percent), here and throughout the description unless otherwise defined, refers to the relative weight of the respective component based on the overall weight of the formulation.

In a first aspect, the invention provides for an object database comprising a set of object entries, which comprise object properties, whereby said object properties comprise obtained object properties, which comprise DHM-obtained object properties and preferably object identification properties, characterized in that said DHM-obtained object properties comprise properties derived from information about a sample comprising said objects, said information acquired by a digital holographic microscope (DHM) and whereby preferably said object identification properties comprise information about the objects which allow identification of the object between the object database and a, preferably external, database.

Digital holographic microscopy allows for a non-expensive, quantitative, fast and straightforward method for visualizing and obtaining information on objects, with a high resolution. In DHM, a holographic representation is recorded by a digital camera such as a CCD- or a CMOS-camera, which can subsequently be stored or processed on a computer. DHM allows for the acquirement of highly detailed information on a wide range of objects from different nature. DHM is furthermore non-destructive, and does not require for an object to be altered or prepared prior to obtaining object properties. Since DHM allows for obtaining a large collection of object properties linked to said object, there is need for a method to store and evaluate or analyze the latter in an easy way. The current invention provides for a database which allows to store said object entries as well as the object properties derived thereof, obtained by algorithms and/or comparisons with threshold values.

Digital Holographic Microscopy (DHM) is a technique which allows a recording of a 3D sample or object without the need of scanning the sample layer-by-layer. In this respect DHM is a superior technique compared to for instance confocal microscopy. To make a holographic representation, or hologram, traditionally a highly coherent or a partially coherent light source, e.g. laser-light, is used to illuminate the sample. In the most basic set-up, the light from the source is split into two beams, an object beam and a reference beam. The object beam is sent via an optical system to the sample and interacts with it, thereby altering the phase and amplitude of the light depending on the object's optical properties and 3D shape. The object beam which has been reflected on or transmitted through the sample, is then made (e.g. by set of mirrors and/or beam splitters) to interfere with the reference beam, resulting in an interference pattern which is digitally recorded. Since the hologram is more accurate when object beam and reference beam have comparable amplitude, an absorptive element can be introduced in the reference beam which decreases its amplitude to the level of the object beam, but does not alter the phase of the reference beam or at most changes the phase globally, i.e. not dependent on where and how the reference beam passes through the absorptive element. The recorded interference pattern contains information on the phase and amplitude changes which depend on the object's optical properties and 3D shape.

An alternative way of making a hologram is by using the in-line holographic technique. In-line DHM is similar to the more traditional DHM, but does not split the beam, at least not by a beam splitter or other external optical element. In-line DHM is most preferably used to look at a not-too-dense solution of particles, e.g.

cells, in a fluid. Thereby some part of the at least partially coherent light will pass through the sample without interacting with the particles (reference beam) and interfere with light that has interacted with the particles (object beam), giving rise to an interference pattern which is recorded digitally and processed. In-line DHM is used in transmission mode, it needs light with a relatively large coherence length, and cannot be used if the samples are too thick or dense.

Another DHM technique called differential DHM (DDHM) is disclosed in European patent EP 1 631 788. DDHM is different to the other techniques in that it does not really make use of reference and object beams. In a preferred set-up of DDHM, the sample is illuminated by illumination means which consist of at least partially coherent light in reflection or in transmission mode. The reflected or transmitted sample beam can be sent through an objective lens and subsequently split in two by a beam splitter and sent along different paths in a differential interferometer, e.g. of the Michelson or Mach-Zehnder type. In one of the paths, a beam-bending element or tilting means is inserted, e.g. a transparent wedge. The two beams are then made to interfere with each other in the focal plane of a focusing lens and the interference pattern in this focal plane is recorded digitally and stored by e.g. a CCD-camera connected to a computer. Hereby, due to the beam-bending element, the two beams are slightly shifted in a controlled way and the interference pattern depends on the amount of shifting. Then the beam-bending element is turned, thereby altering the amount of shifting. The new interference pattern is also recorded. This can be done a number N of times, and from these N interference patterns, the gradient (or spatial derivative) of the phase in the focal plane of the focusing lens can be approximately computed. This is called the phase-stepping method, but other methods of obtaining the phase gradient are also known, such as a Fourier transform data processing technique. The gradient of the phase can be integrated to give the phase as a function of position. The amplitude of the light as a function of position can be computed from the possibly but not necessarily weighted average of the amplitudes of the N recorded interference patterns. Since phase and amplitude are thus known, the same information is obtained as in a direct holographic method (using a reference and an object beam), and a subsequent 3D reconstruction of the object can be performed. Therefore, in one embodiment, the DHM-obtained object properties are obtained from images and/or recordings made by a differential DHM and/or an inline DHM. In another embodiment, said DHM-obtained object properties are obtained from images and/or recordings made by a DHM in reflection and/or transmission mode, such as a DDHM in reflection and/or transmission mode.

The DHM used in the current invention to obtain the DHM-obtain object properties can comprise a conventional digital holographic microscope (DHM), or a differential digital holographic microscope (DDHM). It is to be understood that the use of the term DHM in the current application implies all types of digital holographic microscopes, and is not merely limited to conventional DHM.

The term “object” as used herein refers to any specimen who is able to be captured by digital holographic microscopy and is equal or bigger than the detection limits of a holographic microscope. Said object may comprise, but is not limited to a specimen obtained from a chemical reaction, such as a catalytic reaction, a cell specimen, such as a blood sample, a sperm sample, a urine sample, etc., a soil specimen, a specimen comprising micro-organisms and/or insects, a forensic specimen or a specimen from a crime scene, such as, but not limited to a hair specimen, body fluids, a water specimen, an entomological specimen.

The term “object database” as used herein refers to a database comprising information on objects, whereby the objects in the context of this document can be found or are contained in samples for inspection or visualization by a digital holographic microscope. The object database may be an object-oriented database, but is not restricted thereto. The object database may also be e.g. a relational database or any other type of database.

In a further embodiment, said set of object entries comprise further general object properties and/or derived object properties.

For the purpose of current invention, said general object properties may be interpreted as comprising general information of object entries which can be used for internal reference and/or for bookkeeping purposes. In a more preferred embodiment, said general object properties may comprise a unique object entry ID, a time stamp for identifying the time at which an object entry was included in the database, information of the system having accessed the database at the time of entry, or any combination thereof.

The object identification properties may comprise sample ID info (e.g. a number related to the sample vial barcode/RFID tag), image ID info (e.g. a number referring to an external database connected to the DHM who has obtained the DHM-obtained object properties), general patient ID info (e.g. age, gender, residential area, . . . ), sample information (e.g. place and time when the sample was taken), owner ID info (e.g. the name of the user/institution from which the info comes from), DHM-ID info (e.g. a serial number of the DHM with which the DHM-obtained object properties are measured or observed), inherent characteristics of the sample (such as for instance refraction index of the sample or of a medium in the sample) etc. or any combination thereof.

In an embodiment, the external database which is connected to the DHM, may comprise a distributed database and/or a cloud database.

General object properties are to be seen as properties which can be accorded to an object entry, independent from the nature or origin of that object entry. They are typically needed in any database for internal reference and for monitoring and updating the correct operation of the database and the system running the database. Object identification properties depend completely on the object and its origin.

The same object, when entered into the database at two different times, should have the same object identification properties each time, but may have and/or will have different general object identification properties at the different times. This way, two entries of the same object into the database, can still be treated separately.

Objects cannot always be separated easily within a sample. This makes it hard to identify the objects in an automated way, i.e. it may be hard to tell in an automated way where one object ends and the other object begins. A DHM offers a three-dimensional view on objects in a sample which is being analyzed by the DHM. Due to this three-dimensional nature of information on the sample as acquired by DHM, identifying individual objects in the sample is easier and less error-prone than in other visualization techniques. Therefore, in an embodiment, at least one object has been identified as a separate object within the sample on the basis of holographic information obtained by said DHM. Preferably, said holographic information comprises three-dimensional information. Thereby, at least one of said object identification properties, such as the three-dimensional position of the object and/or the object's boundaries within the sample, may be obtained by said DHM or derived from DHM-obtained properties. In a preferred embodiment, said derived object properties result from the analysis of said obtained object properties by algorithms and/or threshold values comparison. Said derived object properties have been derived from the obtained object properties and/or other derived object properties of an object entry, depending on algorithms and threshold values which are implemented at the side of the object database, as opposed to the DHM- or user-side, and also possibly dependent on object properties of other object entries. In a more preferred embodiment, said derived object properties comprise the object class to which the object belongs, such as for instance cell type (in case the objects are cells), fingerprinting of the objects in a sample (e.g. identification of objects based on a comparison of obtained parameters with a collection of known parameters correlated to a specific identity or sort of object) cell scoring factor (e.g. in case the classes are linked to oncological classification), sample scoring factor (e.g. in case a scoring factor is computed on the basis of all object entries which have the same sample ID info), etc. or any combination thereof.

Objects in a sample can be of different nature or belong to different types. Recognition of an object or classification according to its type is a process which is notoriously difficult to realize automatically. The present invention may ease this process. Objects can be recognized by their fingerprint, which can be seen as a minimal or quasi-minimal set of characteristics which is unique to the type to which the object belongs. In order to increase the efficiency and reduce errors in a fingerprinting recognition process, an extensive database comprising a lot of information on similar objects as well as an updating method for the database and the algorithms, including the fingerprinting algorithms, can be of great service. Such a database may help to identify which set of characteristics are unique to a specific type and may comprise an algorithm leading to one or more derived object properties which identify and/or classify the object. One example can be the classification of cells into malignant or benign cells. As a DHM provides essentially three-dimensional information, the number of accessible properties which can be used for the fingerprinting algorithm can be drastically increased compared to other microscopic techniques. A DHM provides further advantages in combination with a database of the present invention, as it is e.g. more easily integrated into a digital environment than more classical microscopic techniques, including other 3D-imaging techniques, and is able to acquire 3D information at greater speed than other techniques, leading to a larger database at shorter time. Therefore, in a preferred embodiment, said database comprises a fingerprinting algorithm for classifying an object according to its type, said algorithm taking into account at least one DHM-obtained object property, preferably a property comprising three-dimensional information.

In a preferred embodiment, said derived object properties may be used for internal reference only, or may be communicated to the user for providing the user with object- and/or sample-characterization and/or diagnostic info.

In one embodiment, said object database is stored on an internal server of the practitioner. Preferably, said object database is stored on an external server, accessible by a user from a distinct location.

In a preferred embodiment, said set of object entries are dynamic and updatable, preferably based upon feedback by user. The latter allows for a database which is constantly up-to-date based on new findings and feedback by a large community of users. This enhances this trustworthiness of the database and its reliability.

Feedback on the derived object properties may help to check and update the algorithms and/or threshold values which lead to the derived object properties. The better the feedback, the better these checks and updates will be. In order to improve the quality of the feedback, opinions of many users or specialists in the field may be collected. Therefore, in a preferred embodiment, said database may be connected to an online social network for improving the feedback quality. In a more preferred embodiment, each user providing feedback is awarded a trust factor representing the quality of his feedback, said trust factor preferably based on the quality of previous feedback given by that user.

The database, system and updating method of the present invention further lend themselves to collaborative diagnostics, whereby obtained object properties and at least one derived object properties of an object are incorporated into the database and presented to a community of specialists. Hereby, the specialists may provide their opinion on the one or more presented derived object properties for a specific object. As such, collaborative diagnostics can be seen as a type of feedback on an object-by-object, or rather object entry-by-object entry basis. Therefore, in a preferred embodiment, the database may be connected to a network of users, e.g. an online social network, whereby users are allowed to obtain at least one obtained, preferably DHM-obtained, object property and at least one derived object property of a specific object, and/or whereby at least one obtained, preferably DHM-obtained, object property and at least one derived object property can be communicated to said network of users.

In one embodiment, said object comprises a DHM analyzable object. In another, more preferred embodiment, said object comprises a cell sample, a fluid, a body fluid, a sample comprising micro-organisms, an entomological sample or a soil sample. In a most preferred embodiment, said object is a cell sample. Said cell sample is to be understood as any specimen obtained from a biological organism, preferably a living organism, which comprises cells from said biological organism. The term relates also to specimen obtained from non-living, i.e. dead biological organisms, in particular recently deceased organisms. In preferred embodiments of the present invention a cell sample may be derived from an animal, preferably from a mammal, e.g. from a cat, a dog, a swine, a horse, a cattle, a sheep, a goat, a rabbit, a rat, a mouse, a monkey. Particularly preferred is a sample obtained from a human being. Said cell sample may comprise cells on a substratum, such as a microscope glass. In another embodiment, said cell sample is a liquid cell sample. For purpose of the current invention, the term “liquid cell sample” is to be understood as a cell sample in a state of suspension. Said suspension might depend to the nature of the cell sample (e.g. blood, excretions . . . ) or on the nature of preservation of the obtained sample, for instance by adding a buffering solution, or an alcohol. In a more preferred embodiment, said sample is a cervical sample. In the latter case, said object entries relate to cells in a sample and said DHM-obtained object properties comprise cell size, cell nuclear size, cell optical height, cell nucleus optical height, etc.

Updating and/or improving the database can occur via feedback on the derived object properties, which are communicated to the user. The user is asked to provide his own characterization and/or diagnostic info of an object or sample, and this information is communicated back to a server which has access to the object database. The user's feedback is compared with the derived object properties of object entries. In case of differences, the algorithms and/or thresholds used to compute the derived object properties can be altered, improved, assessed, etc. This feedback will be resend to said server where the feedback of the user can be compared to the object entries in the database. The latter will serve as a constant quality control of the derived object entries as well as the threshold and the algorithms used for analysis of the object entries. Thus a dynamic database is provided which will be constantly adapted and updated, based on the findings of said users.

Therefore, in a further aspect, the present invention provides an object database updating method for improving the characterization of objects which are analyzable by a digital holographic microscope, comprising the steps of:
providing a database comprising object properties, whereby said object properties comprise obtained object properties, which comprise DHM-obtained object properties and at least one derived object property, said object database comprising at least one object entry, whereby said derived object property of said object entry is derived, preferably from said DHM-obtained object properties, using algorithms and/or threshold values, preferably predefined algorithms and/or threshold values;
communicating said derived object property of said object entry to a user of said object database;
obtaining and/or awaiting feedback on said derived object property of said object entry from said user;
comparing said feedback with said derived object property of said object entry, hereby obtaining comparison information; and
updating said algorithms and/or threshold values according to said comparison information,
   characterized in that said DHM-obtained object properties comprise properties derived from information acquired by a digital holographic microscope (DHM).

Preferably, said obtained database properties is send to said database stored on a server, either an internal server or an external server.

In another aspect, the current invention discloses equally a computing system or server comprising an object database and object database updating method as disclosed in the current invention.

In yet a further aspect, the present invention discloses a system comprising an object database according to this document and a digital holographic microscope operably connected to said database. This system may further be arranged to update said database using an object database updating method as disclosed in this document.

The invention is further described by the following non-limiting examples which further illustrate the invention, and are not intended to, nor should they be interpreted to, limit the scope of the invention.

### EXAMPLES

### Example 1

### Detecting and Classifying (Pre-)Malignant Cells in a Cell Sample

An object, being a cell sample, preferably a liquid cell sample such as a cervical sample, may be obtained from a patient. The sample will be analyzed by a digital holographic microscope (DHM) and the practitioner will be provided with a digital report, comprising a set of cellular parameters related to cells present in the cell sample as well as with diagnostic information on the cell sample (the derived object properties). This will give the practitioner or pathologist the chance to evaluate the raw sample in an unbiased manner, by taking the provided cell sample parameters into account. Diagnosis can be solely based on the report provided by the system, or if desirable, the practitioner or pathologist can proceed by more conventional means of diagnosing. Digital holographic microscopy enables the study of living cells without the need for markers or dyes, and enables quantitative analysis of the studied cells as well as various sub-sections of said cells by obtaining a three-dimensional image.

The sample is analyzed by DHM, providing for DHM-obtained object properties. Simultaneously, object identification properties are equally obtained, under the form of for instance patient data, sample vial number, preferably related to an RFID or barcode on the vial, or a numerical code which correspond to the database system used by the practitioner. Both the DHM-obtained and the object identification properties are send to a server, where they are stored in a database. Said server may be an internal server or an external server. Algorithms and threshold factors are provided, for the analysis of the DHM obtained properties of the sample, in order to provide diagnostic information, related to the status of the cell sample. The derived object properties will comprise cellular parameters, whereby the cellular parameters may comprise optical nuclear height, cell quantity, nuclear size, nuclear volume, nuclear size variability, nuclear volume variability, chromatin texture, cell size, cell form or shape and cell morphology or any combination thereof such as ratios. For instance, in the current example where the object is a cervical sample, detection of cancerous or pre-malignant cells may occur based on the analysis of the DHM obtained database object properties. Furthermore, Scoring Factors may be appointed to each individual cell present in the sample based on the derived cell parameters, whereby the Scoring Factors represent an indication of the status of each cell, whereby this status is correlated to a cell staging system. The algorithms and thresholds are specifically related to the derived properties of the object, and serve to evaluate the latter. The practitioner is provided with these derived object properties under the form of a digital report. Said digital report presents a diagnostic tool for the practitioner to evaluate the cell sample. The practitioner presented with the digital report can indicate whether in his opinion, the derived properties matches with his own personal diagnosis. This opinion will be resent to said external server where the opinion of the practitioner can be compared to the information stored in the database. The latter will serve as a constant quality control of the database and the algorithms and/or thresholds used for analysis and provides for a dynamic system as the database and the algorithms will be constantly adapted and updated, based on the findings of said practitioners.

### Example 2

### Detecting and Identifying Micro-Organisms in a Sample

A sample is provided which comprises micro-organisms that are wished to be identified, as well as quantified. The sample may for instance be a blood sample or a urine sample, which requires detection or diagnosis of a potential infection. The sample might furthermore also be an aquatic sample, for instance from a river, or pond, in order to identify the algae and aquatic micro-organisms present in the sample. The sample is analyzed by DHM, obtaining information and parameters related to the sample and the microorganisms present in the sample. This information is send to the database according to the current invention. Additionally, identification information linked to the sample can be sent along, comprising info on the date of sampling, location of sampling, patient id, vial code, etc. The obtained information is subsequently subjected to algorithms and compared to threshold data and/or reference parameters (such as reference characteristics of certain micro-organisms, for instance shape of the micro-organisms, presence of organelles, etc.) stored in the database, whereby data is derived from the obtained holographic information. These derived data might comprise for instance the nature or identity of the micro-organisms or the amount of micro-organisms present in the sample. This information is sent back to the practitioner which has asked for the analysis. Based on the findings of this analysis, the practitioner might further process the sample, or verify the derived data. If the practitioner suspects faults in the derived data, this might be reported, after which the database can be adapted. Alternatively, if new findings arise in a certain field, these findings can equally be reported, and result in an update of the database and the algorithms and thresholds used for the analysis of the obtained data. The data stored in the database will present a vast collection of information, from various locations and practitioners, and presents as such an interesting reference guide which can be consulted and which can be used as starting material for various studies (such as geographic spreading of the presence of certain micro-organisms or subtypes, predictions of epidemics, pandemics, etc.)

### Example 3

### Quality Check of Sperm Sample

A third application of the current invention lies in the fertility field, more precisely the quality check of sperm. Holographic information is obtained by the practitioner and sent to the database, together with identification data related to the sample. Parameters such as sperm count, sperm viability, characteristics of the sperm cells are computed and send back to the practitioner. The database storing all data entries can be constantly updated upon feedback of the users, hence offering a very reliable analysis tool.

### Example 4

### Soil Analysis

A soil sample is analyzed by DHM and obtained information, together with the specifics of the sample (such as place of sampling, time-point, etc.) is communicated to the database. Derived information from the holographic information may comprise for instance the composition of the soil, nature and quantification of the soil particles, physic-chemical properties of the soil, micro-organisms present in the soil, etc. The derived data is subsequently reported back to the user, allowing the user to provide feedback to the system in order to update the database based on the feedback.

1. An object database for storing information about objects in a sample, whereby said objects are analyzable by a digital holographic microscope, said database comprising a set of object entries, which comprise object properties, whereby said object properties comprise obtained object properties, which comprise digital holographic microscope (DBM)-obtained object properties and object identification properties,
characterized in that said DEM-obtained object properties comprise properties derived from information about said sample comprising said objects, said information acquired by a (DEM) and whereby preferably said object identification properties comprise information about the object which allows identification of the object between the object database and an external database.

2. An object database according to claim 1, whereby said set of object entries comprise further general object properties and/or derived object properties.

3. An object database according to claim 2 wherein said derived object properties result from the analysis of said obtained object properties by algorithms and/or threshold values comparison.

4. An object database according to claim 1, wherein said object database is stored on an external server, accessible by a user from a distinct location.

5. An object database according to claim 1, wherein said object database is stored on an internal server.

6. An object database according to claim 1, wherein said set of object entries are dynamic and updatable, preferably based upon feedback by user.

7. An object database according to claim 1, wherein said object comprises a cell sample, a fluid, a body fluid, a sample comprising micro-organisms, an entomological sample or a soil sample.

8. An object database according to claim 7, whereby said object is a cervical cell sample.

9. An object database according to claim 1, wherein at least one object has been identified as a separate object within the sample on the basis of holographic information obtained by said DHM.

10. An object database according to claim 1, comprising a fingerprinting algorithm for classifying an object according to its type, said algorithm taking into account at least one DHM-obtained object property.

11. An object database updating method for improving the characterization of objects which are analyzable by a digital holographic microscope (DEM), comprising the steps of:
providing a database comprising object properties, whereby said object properties comprise obtained object properties, which comprise DHM-obtained object properties and at least one derived object property, said object database comprising at least one object entry, whereby said derived object property of said object entry is derived, preferably from said DHM-obtained object properties, using predefined algorithms and/or threshold values;
communicating said derived object property of said object entry to a user of said object database;
obtaining and/or awaiting feedback on said derived object property of said object entry from said user;
comparing said feedback with said derived object property of said object entry, hereby obtaining comparison information; and
updating said algorithms and/or threshold values according to said comparison information,
wherein said DEM-obtained object properties comprise properties derived from information acquired by a digital holographic microscope (DHM).

12. An object database updating method according to claim 11, sending said obtained properties to said database stored on an external server.

13. An object database updating method according to claim 11, sending said obtained properties to said database stored on an internal server.

14. An object database updating method according to claim 11, wherein said object comprises a cell sample, a fluid, a body fluid, a sample comprising micro-organisms, an entomological sample or a soil sample.

15. An object database updating method according to claim 14, wherein said object is a cervical cell sample.

16. A system comprising an object database according to claim 1 and a digital holographic microscope operably connected to said database, said system arranged to update said database using an object database updating method.

17. Computing system comprising an object database and object database updating method as according to claim 1.
